(19) United States
(12) Patent Application Publication
(10) Pub. No.: US 2018/0142764 A1
(43) Pub. Date: May 24, 2018

(54) GEAR UNIT, REDUCER, AND REDUCER-EQUIPPED MOTOR

(71) Applicant: MABUCHI MOTOR CO., LTD., Chiba (JP)

(72) Inventor: Yousuke ISAKA, Tokyo (JP)

(21) Appl. No.: 15/817,312

(22) Filed: Nov. 20, 2017

(30) Foreign Application Priority Data
Nov. 21, 2016 (JP) 2016-225915

(51) Int. Cl. F16H 1/20; F16H 55/06; H02K 7/116

(52) U.S. Cl. CPC F16H 1/203; H02K 7/1166; F16H 55/06

(57) ABSTRACT

In a gear unit including two gears engaging with each other, tooth portions of the two gears have material strengths different from each other. Of the two gears, a first gear with a higher material strength of the tooth portion is laterally shifted in the direction of decreasing a tooth thickness. Of the two gears, a second gear with a lower material strength of the tooth portion is laterally shifted in the direction of increasing the tooth thickness.

### BACKGROUND

### 1. Technical Field

The present disclosure relates to a gear unit configured such that tooth portions of two gears engaging with each other have different material strengths, a reducer using the gear unit, and a reducer-equipped motor including the reducer.

### 2. Description of the Related Art

A reducer-equipped motor is configured such that a motor as a power source and a reducer including a plurality of gears are integrated together. For example, the reducer-equipped motor is used for a power window system of a vehicle. For the reducer, the number of reduction stages and the shape (a diameter, a tooth width, a tooth thickness, and the like) of each gear are set so that a desired reduction ratio can be satisfied while strength and durability can be ensured. For example, JP-A-2015-64061 discloses a reducer including at least three or more reduction gears. In this technique, a configuration of a support portion configured to support the reduction gears is designed so that size reduction in a radial direction of an output shaft can be realized. Note that in JP-A-2015-64061, each gear is molded from a resin material.

At least two gears having different diameters are provided to engage with each other in the reducer. In the case of molding these two gears from the same resin material, the strength of the small-diameter gear tends to be insufficient. In response, the strength may be increased by an increase in the diameter or tooth width of the small-diameter gear. However, an increase in the diameter or tooth width of the small-diameter gear leads to an increase in the diameter or tooth width of the large-diameter gear. For this reason, it is difficult to realize size reduction and weight reduction of the reducer. Note that such a problem is not limited to the reducer of the reducer-equipped motor, and is a common problem among gear units each including two gears engaging with each other.

### SUMMARY

The present disclosure has been made in view of the above-described problem, and one object of the present disclosure is to ensure, in a gear unit including two gears engaging with each other, the strength of the two gears without a size increase. Another object of the present disclosure is to provide a reducer and a reducer-equipped motor which are configured so that the strength of the built-in gears can be ensured while size reduction can be realized. Note that the present disclosure is not limited to these objects, and still another object of the present disclosure is to provide features and advantageous effects which are derived from each configuration described in a later-described embodiment and cannot be obtained by a typical technique.

(1) The gear unit disclosed herein is a gear unit including two gears engaging with each other. Tooth portions of the two gears have material strengths different from each other. Of the two gears, a first gear with a higher material strength of the tooth portion is laterally shifted in the direction of decreasing a tooth thickness. Of the two gears, a second gear with a lower material strength of the tooth portion is laterally shifted in the direction of increasing the tooth thickness.

(2) The tooth thickness of the first gear is preferably set based at least on the material strength of the first gear such that the tooth root bending strength of the first gear reaches equal to or greater than a predetermined value. Note that the predetermined value is more preferably the tooth root bending strength of the second gear.

(3) The tooth portion of the first gear is preferably made of metal, and the tooth portion of the second gear is preferably made of resin.

(4) The first gear is preferably integrally molded from sintered metal, and the second gear is preferably integrally molded from resin.

(5) The first gear preferably has a smaller diameter than that of the second gear.

(6) The gear unit preferably further includes a third gear positioned on an axis identical to that of the first gear, fixed to the first gear, and having a resin tooth portion; and a worm engaging with the third gear and having a metal tooth portion.

(7) The reducer disclosed herein includes the gear unit according to (6) citing (5). The worm is an input element to which rotation of a power source is transmitted, and the second gear is an output element.

(8) The reducer-equipped motor disclosed herein includes a motor portion including a rotor and a stator; and the reducer according to (7), the reducer being coupled to a rotary shaft of the motor portion.

According to the disclosed gear unit, the strength of the first gear is increased by a material quality. The tooth thickness is decreased by the increased strength, and the tooth thickness corresponding to such a decrease is utilized for ensuring the second-gear-side strength. Thus, the strength of both gears can be ensured. That is, the strength can be ensured without increasing the sizes (the diameters or tooth widths) of the two gears, and the size of the gear unit can be reduced.

Moreover, according to the disclosed reducer and the disclosed reducer-equipped motor, the strength of the built-in gears can be ensured while size reduction can be realized.

### BRIEF DESCRIPTION OF THE DRAWINGS

FIG. 1 is a transparent plan view of a gear case of a reducer-equipped motor of an embodiment;

FIG. 2 is a perspective view of a gear unit built in the reducer-equipped motor of FIG. 1; and

FIGS. 3A and 3B are views for describing lateral shifting of each tooth portion of a small-diameter gear and a large-diameter gear, FIG. 3A being an enlarged view (a view of an engagement state between the gears after lateral shifting) of a K portion of FIG. 1 and FIG. 3B being a view of the engagement state between the gears before lateral shifting.

### DESCRIPTION OF THE EMBODIMENTS

An example where a gear unit of an embodiment is applied to a reducer provided at a reducer-equipped motor will be described with reference to the drawings. The embodiment described later will be set forth merely as an example, and is not intended to exclude application of various modifications and techniques not clearly described in the following embodiment. Various modifications can be made to each configuration of the present embodiment without departing from the gist of such a configuration. Moreover, these configurations may be chosen as necessary, or may be combined together as necessary.

### 1. Configuration

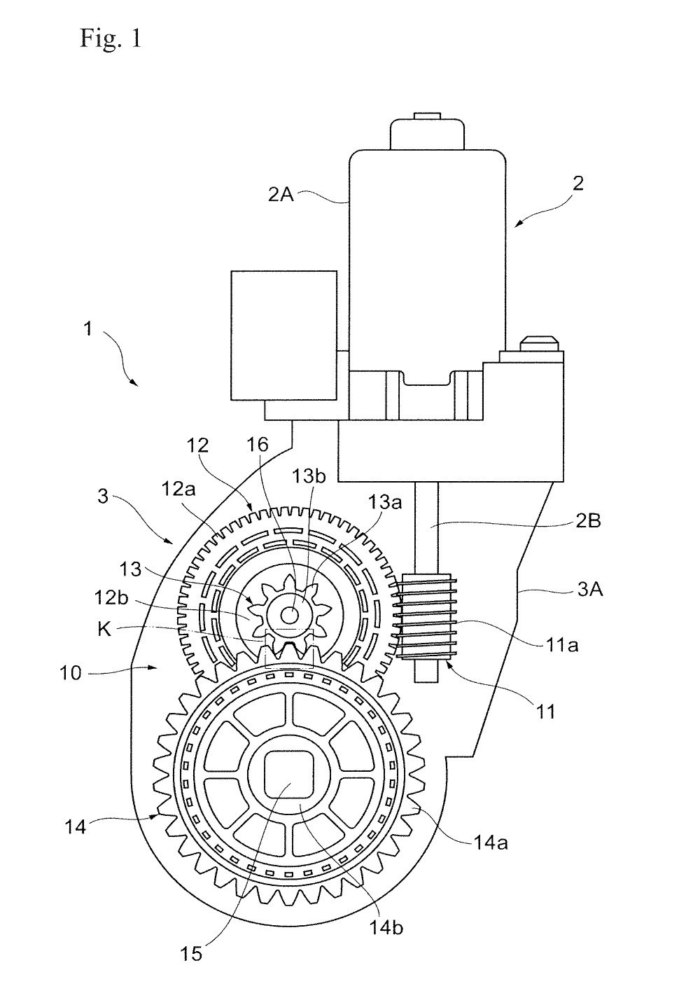

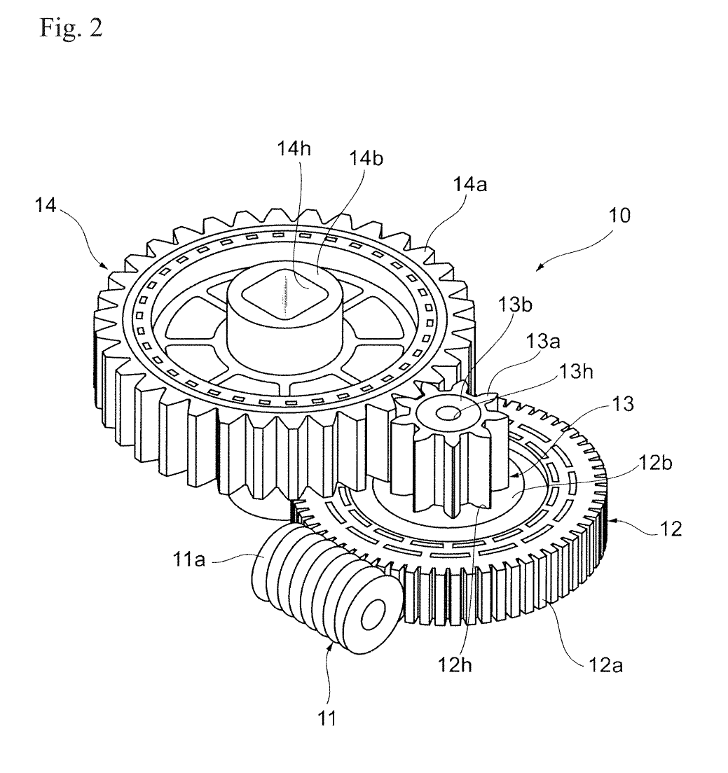

First, a configuration of a reducer-equipped motor 1 (hereinafter referred to as a “motor 1”) of the present embodiment will be described. FIG. 1 is a transparent plan view of a gear case 3A of the motor 1 of the present embodiment, and FIG. 2 is a perspective view of a gear unit 10 provided at the motor 1 of FIG. 1. In the present embodiment, a motor 1 applied to a power window system of a vehicle will be described as an example.

As illustrated in FIG. 1, the motor 1 includes a motor portion 2 (a power source) configured to generate output, and a reducer 3 configured to reduce the speed of rotation of the motor portion 2. The motor portion 2 is, e.g., a brush DC motor, and has a rotor and a stator (both not shown) built in a housing 2A. One end of a rotary shaft 2B of the motor portion 2 is supported by the housing 2A, and the other end of the rotary shaft 2B extends into the gear case 3A joined to the housing 2A.

The reducer 3 includes the gear unit 10 having an input element coupled to the rotary shaft 2B of the motor portion 2 and an output element configured to output power of the motor portion 2 to a drive target member (e.g., a not-shown window regulator). The gear unit 10 of the present embodiment has a worm 11 (an input element) to which rotation of the motor portion 2 is transmitted, a worm wheel 12 (a third gear) engaging with the worm 11, and two gears 13, 14 engaging with each other. The gear unit 10 of the present embodiment is built in the gear case 3A. Note that the two gears 13, 14 have pitch circle diameters different from each other. When these gears are distinguished from each other in description below, the gear 13 (a first gear) with a smaller diameter will be referred to as a “small-diameter gear 13,” and the gear 14 (a second gear) with a larger diameter will be referred to as a “large-diameter gear 14.” That is, the reducer 3 of the present embodiment employs a double-reduction method.

As illustrated in FIGS. 1 and 2, the worm 11 is a gear fixed, by press-fitting, to the other end side of the rotary shaft 2B to rotate together with the rotary shaft 2B, and functions as the input element to which rotation of the motor portion 2 is transmitted. The worm wheel 12 is a gear engaging with the worm 11, and is provided rotatable relative to a support shaft 16 disposed parallel to a later-described output shaft 15. Note that the support shaft 16 is fixed to the gear case 3A.

A boss portion 12b of the worm wheel 12 is provided with a through-hole (not shown) and a gear hole 12h, the support shaft 16 being inserted into these holes. Note that the “boss portion” described herein means a gear center portion in a radial direction, a hole for fixing or insertion of the shaft being formed at the gear center portion. A “tooth portion” means a circular ring shaped portion (i.e., a portion excluding the boss portion) including multiple teeth arranged in a circumferential direction. The gear includes the boss portion and the tooth portion.

The gear hole 12h of the boss portion 12b is a hole for fixing the small-diameter gear 13 to the worm wheel 12, and one end portion of a tooth portion 13a of the small-diameter gear 13 in an axial direction is, by press-fitting, fixed in a serration joint state.

The small-diameter gear 13 has the tooth portion 13a and a boss portion 13b provided with a through-hole 13h, the support shaft 16 being inserted into the through-hole 13h. The small-diameter gear 13 is configured to rotate together with the worm wheel 12 to transmit rotation of the motor portion 2 to the large-diameter gear 14. The worm wheel 12 and the small-diameter gear 13 are arranged on the same axis in a fixed state, and are provided rotatable relative to the support shaft 16.

The large-diameter gear 14 has a tooth portion 14a and a boss portion 14b provided with a shaft hole 14h, the output shaft 15 being fitted in the shaft hole 14h. The large-diameter gear 14 is provided such that the tooth portion 14a thereof engages with the tooth portion 13a of the small-diameter gear 13, and rotation of the small-diameter gear 13 rotating together with the worm wheel 12 is transmitted to the large-diameter gear 14. Rotation of the large-diameter gear 14 is transmitted to the drive target member through the output shaft 15, and therefore, the large-diameter gear 14 has a function as the output element.

Next, the gear unit 10 provided at the reducer 3 will be described. The gear unit 10 is configured such that the tooth portions 13a, 14a of the two gears 13, 14 have material strengths different from each other.

In the present embodiment, the tooth portion 13a of the small-diameter gear 13 has a higher material strength than that of the tooth portion 14a of the large-diameter gear 14. In other words, the small-diameter gear 13 has the tooth portion 13a with a relatively-high material strength, and the large-diameter gear 14 has the tooth portion 14a with a relatively-low material strength. The material of the tooth portion 13a of the small-diameter gear 13 includes, for example, typical high-strength materials such as metal (iron and the like) and super engineering plastic (polyetheretherketone, polyamide-imide, and the like). Moreover, the material of the tooth portion 14a of the large-diameter gear 14 may be a material having a lower material strength than that of the small-diameter gear 13, and includes, for example, metal (aluminum and the like) and engineering plastic (polyacetal, polycarbonate, nylon, and the like).

In the present embodiment, the small-diameter gear 13 is integrally molded from sintered metal, and the large-diameter gear 14 is integrally molded from lower-strength resin than that of the small-diameter gear 13. That is, the tooth portion 13a of the small-diameter gear 13 is made of metal, and the tooth portion 14a of the large-diameter gear 14 is made of resin. Note that the small-diameter gear 13 and the large-diameter gear 14 are each not necessarily integrally molded (the tooth portion and the boss portion are made of the same material), and the tooth portion and the boss portion may be made of different materials.

Moreover, the gear unit 10 of the present embodiment is configured such that a tooth portion 11a of the worm 11 is made of metal (e.g., iron or brass) and that a tooth portion 12a of the worm wheel 12 is made of resin (e.g., engineering plastic such as polyacetal and polycarbonate). Note that the worm 11 and the worm wheel 12 may be each integrally molded (the tooth portion and the boss portion are made of the same material), or the tooth portion and the boss portion may be made of different materials.

Of the tooth portions of the engaging gears in the gear unit 10 of the present embodiment, one tooth portion is made of resin, and the other tooth portion is made of metal. Specifically, the tooth portion 12a of the worm wheel 12 engaging with the metal tooth portion 11a of the worm 11 is made of resin, and the tooth portion 14a of the large-diameter gear 14 engaging with the metal tooth portion 13a of the small-diameter gear 13 is made of resin. This reduces noise.

Further, in the gear unit 10 of the present embodiment, the small-diameter gear 13 is laterally shifted in the direction of decreasing a tooth thickness, and the large-diameter gear 14 is laterally shifted in the direction of increasing the tooth thickness. Hereinafter, the former lateral shifting will be referred to as “negative lateral shifting,” and the latter lateral shifting will be referred to as “positive lateral shifting.” Note that the “lateral shifting” described herein means that only the tooth thickness is increased/decreased without a change in the positions of a tooth bottom circle and a tooth tip circle of the gear.

That is, the gear unit 10 is configured such that the strength of the small-diameter gear 13 is increased by a material quality (the material strength). Thus, the strength necessary for the small-diameter gear 13 can be ensured even upon the negative lateral shifting (i.e., even when the tooth thickness is decreased), and the positive lateral shifting of the large-diameter gear 14 is allowed by such negative lateral shifting (a decrease in the tooth thickness). Even when a sufficient strength of the large-diameter gear 14 is not ensured by the material quality (the material strength), the strength of the large-diameter gear 14 can be increased by such positive lateral shifting (an increase in the tooth thickness). Thus, the strength necessary for the large-diameter gear 14 can be ensured.

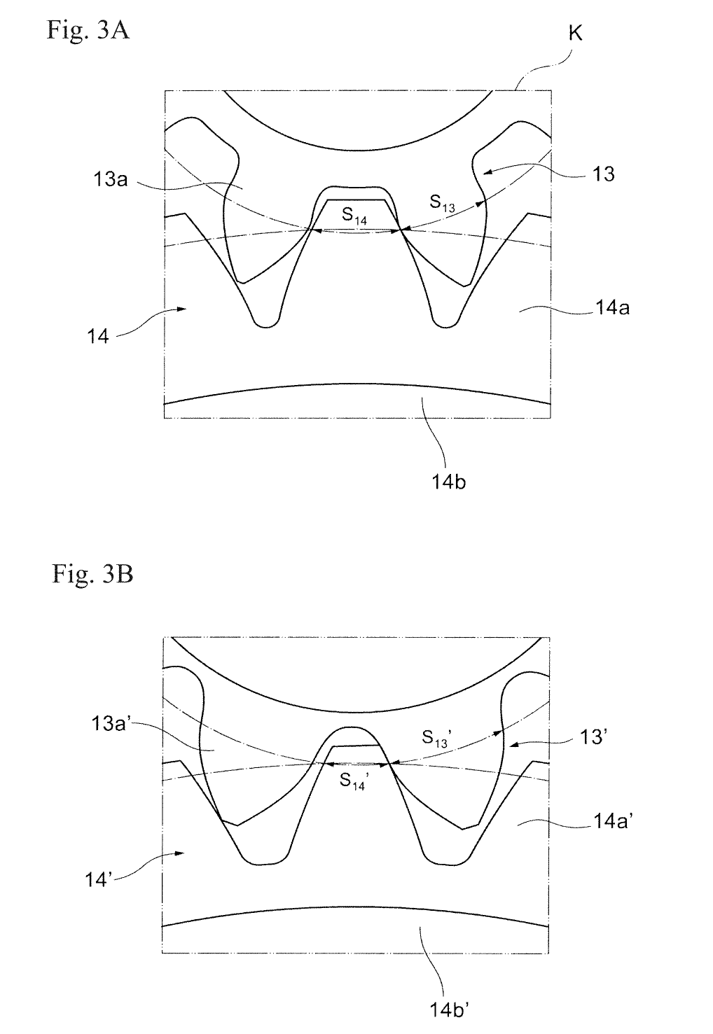

An enlarged view of a K portion of FIG. 1 is illustrated in FIG. 3A. That is, FIG. 3A illustrates an engagement state between the gears 13, 14 with the tooth portions 13a, 14a being laterally shifted. On the other hand, FIG. 3B illustrates an engagement state between the gears 13′, 14′ before the lateral shifting. Note that a tooth width is constant in these figures. Moreover, in these figures, a tooth thickness on a pitch circle (i.e., an arc tooth thickness) is indicated by a reference character S as a representative tooth thickness. Note that a subscript number of the reference character S corresponds to a reference numeral of the gear 13, 14.

As illustrated in FIG. 3A, the tooth thickness S₁₃ of the small-diameter gear 13 having the tooth portion 13a with the relatively-high material strength is set smaller than the tooth thickness S_{13′} illustrated in FIG. 3B. Conversely, the tooth thickness S₁₄ of the large-diameter gear 14 having the tooth portion 14a with the relatively-low material strength is set larger than the tooth thickness S_{14′} illustrated in FIG. 3B. The tooth thickness of the small-diameter gear 13 or the amount (the tooth thickness decrement) of the negative lateral shifting of the small-diameter gear 13 is set based at least on the material strength of the small-diameter gear 13 such that the tooth root bending strength of the small-diameter gear 13 reaches equal to or greater than a predetermined value.

The above-described predetermined value is set to, e.g., the tooth root bending strength of the large-diameter gear 14 or a tooth root bending strength ensured for the gear 13′. In the case of setting the predetermined value to the former value, the tooth thickness (or the negative lateral shifting amount) of the small-diameter gear 13 is set based on the material strength of the small-diameter gear 13 and the material strength of the large-diameter gear 14 such that the tooth root bending strength of the small-diameter gear 13 is equal to or greater than that of the large-diameter gear 14.

For example, the tooth thickness of the small-diameter gear 13 is set such that the decrement of the tooth root bending strength due to the negative lateral shifting is cancelled out by the increment of the tooth root bending strength due to the material strength of the tooth portion 13a. Note that the tooth thickness of the small-diameter gear 13 is set such that no edge is formed at a tooth tip (in other words, a top land is formed at the tooth tip). That is, a value when an edge is formed at the tooth tip or a value obtained by addition of a margin to the above-described value is, as the upper limit, set to the negative lateral shifting amount. The tooth thickness of the small-diameter gear 13 is set such that the negative lateral shifting amount reaches less than such an upper limit.

The tooth thickness (or the positive lateral shifting amount) of the large-diameter gear 14 is calculated (set) by setting of the tooth thickness of the small-diameter gear 13. A greater negative lateral shifting amount results in a greater tooth thickness of the large-diameter gear 14. Thus, a greater negative lateral shifting amount (i.e., a smaller tooth thickness) of the small-diameter gear 13 results in a higher strength of the large-diameter gear 14.

### 2. Advantageous Effects

(1) In the above-described gear unit 10, the tooth portions 13a, 14a of the two gears 13, 14 have the material strengths different from each other, and the gear 13 (the first gear) having the tooth portion 13a with the relatively-high material strength has a smaller tooth thickness. Thus, the tooth thickness of the gear 14 (the second gear) having the tooth portion 14a with the relatively-low material strength can be increased.

That is, the strength of the first gear 13 is increased by the material quality (the material strength). Thus, even when the tooth thickness is decreased by the strength increment, the strength necessary for the first gear 13 can be ensured. Moreover, the tooth thickness of the second gear 14 can be increased by the tooth thickness decrement of the first gear 13. Thus, even when a sufficient strength is not ensured by the material quality (the material strength) of the second gear 14, the strength necessary for the second gear 14 can be ensured.

Thus, according to the above-described gear unit 10, the strength of the two gears 13, 14 can be ensured without a change in the sizes (the diameters or the tooth widths) of the gears 13, 14, leading to size reduction of the gear unit 10. For example, when the negative lateral shifting amount of the first gear 13 is set to a value close to the above-described upper limit, if strength higher than the strength necessary for the first gear 13 can be ensured, the diameter or tooth width of the first gear 13 can be decreased. Thus, according to the above-described gear unit 10, size reduction of the first gear 13 can be easily realized while size reduction of the second gear 14 can be also realized.

(2) In the above-described gear unit 10, the tooth thickness of the first gear 13 is set based at least on the material strength of the gear 13 such that the tooth root bending strength of the gear 13 reaches equal to or greater than the predetermined value. Thus, the tooth root bending strength of the first gear 13 can be ensured while the tooth thickness of the second gear 14 can be increased. Consequently, the strength of both gears 13, 14 can be properly ensured.

(3) According to the above-described gear unit 10, the tooth portion 13a of the first gear 13 is made of metal, and therefore, the gear 13 having the high-strength tooth portion 13a can be manufactured at low cost. On the other hand, the tooth portion 14a of the second gear 14 is made of resin, and therefore, noise can be reduced.

(4) Moreover, in the above-described gear unit 10, the first gear 13 is integrally molded from sintered metal, and the second gear 14 is integrally molded from resin. As described above, the tooth portion 13a, 14a and the boss portion 13b, 14b are integrally molded, and therefore, the configurations of the gears 13, 14 can be more simplified as compared to the case of molding only the tooth portion 13a, 14a from a different material. This can reduce a manufacturing cost. Note that by means of sintered metal, the first gear 13 with the high material strength can be manufactured using a mold, and therefore, the cost for manufacturing the first gear 13 can be further reduced.

(5) In the above-described gear unit 10, the first gear 13 has a smaller diameter than that of the second gear 14. In other words, the small-diameter gear 13 is made of metal, and the large-diameter gear 14 is made of resin. Thus, weight reduction of the gear unit 10 can be realized.

(6) Moreover, in the above-described gear unit 10, the worm wheel 12 fixed to the first gear 13 and the worm 11 engaging with the worm wheel 12 are provided. Moreover, the tooth portion 12a of the former is made of resin, and the tooth portion 11a of the latter is made of metal. That is, the worm wheel 12 having the resin tooth portion 12a is interposed between the worm 11 having the metal tooth portion 11a and the first gear 13 having the metal tooth portion 13a, and therefore, noise can be reduced.

(7) In the above-described reducer 3, the above-described gear unit 10 is provided. Thus, the strength of the built-in gears 13, 14 can be ensured while size reduction can be realized.

(8) Similarly for the motor 1 including the reducer 3, the strength of the built-in gears 13, 14 can be ensured while size reduction can be realized.

### 3. Others

All of the gear unit 10, the reducer 3, and the motor 1 as described above have been set forth as examples, and are not limited to those described above.

For example, the above-described small-diameter gear 13 is not necessarily integrally molded from sintered metal, and the tooth portion 13a and the boss portion 13b may be joined together after having been molded from different materials. Similarly, the above-described large-diameter gear 14 is not necessarily integrally molded from resin.

In the case of molding the small-diameter gear 13 from high-strength resin (e.g., super engineering plastic), the small-diameter gear 13 and the worm wheel 12 may be integrated together. Of the two gears 13, 14, one having the tooth portion 13a with the relatively-high material strength is, in the above-described embodiment, provided as the small-diameter gear 13. However, the gear having the tooth portion with the relatively-high material strength may be the large-diameter gear. That is, the large-diameter gear and the small-diameter gear as described in the above-described embodiment may be interchangeable.

The method for setting the tooth thickness (the negative lateral shifting amount) of the first gear as described above has been set forth as an example, and the tooth thickness may be set considering other elements than above.

Note that the above-described gear unit 10 may be applied not only to the reducer 3, but also to a transmission or a speed-up gear. Moreover, the above-described reducer 3 may be applied to other products than the motor 1.

1. A gear unit comprising two gears engaging with each other, wherein
tooth portions of the two gears have material strengths different from each other,
of the two gears, a first gear with a higher material strength of the tooth portion is laterally shifted in a direction of decreasing a tooth thickness, and
of the two gears, a second gear with a lower material strength of the tooth portion is laterally shifted in a direction of increasing the tooth thickness.

2. The gear unit according to claim 1, wherein
the tooth thickness of the first gear is set based at least on the material strength of the first gear such that a tooth root bending strength of the first gear reaches equal to or greater than a predetermined value.

3. The gear unit according to claim 1, wherein
the tooth portion of the first gear is made of metal, and the tooth portion of the second gear is made of resin.

4. The gear unit according to claim 3, wherein
the first gear is integrally molded from sintered metal, and
the second gear is integrally molded from resin.

5. The gear unit according to claim 3, wherein
the first gear has a smaller diameter than that of the second gear.

6. The gear unit according to claim 5, comprising:
a third gear positioned on an axis identical to that of the first gear, fixed to the first gear, and having a resin tooth portion; and
a worm engaging with the third gear and having a metal tooth portion.

7. A reducer comprising the gear unit according to claim 6, wherein
the worm is an input element to which rotation of a power source is transmitted, and
the second gear is an output element.

8. A reducer-equipped motor comprising:
a motor portion including a rotor and a stator; and
the reducer according to claim 7, the reducer being coupled to a rotary shaft of the motor portion.
